(19) United States
(12) Patent Application Publication
(10) Pub. No.: US 2025/0252878 A1
(43) Pub. Date: Aug. 7, 2025

(54) HEAD-MOUNTED DISPLAY AND LIGHT INTENSITY ADJUSTMENT METHOD THEREOF

(71) Applicant: Coretronic Corporation, Hsin-Chu (TW)

(72) Inventors: Yao-Hung Chen, Hsin-Chu (TW); Wei-Min Chien, Hsin-Chu (TW)

(73) Assignee: Coretronic Corporation, Hsin-Chu (TW)

(21) Appl. No.: 19/026,480

(22) Filed: Jan. 17, 2025

(30) Foreign Application Priority Data
Feb. 2, 2024 (CN) 202410153647.1

(51) Int. Cl. G09G 3/00

(52) U.S. Cl. CPC G09G 3/003; G09G 3/006; G09G 2320/041; G09G 2320/0626; G09G 2330/12; G09G 2360/144; G09G 2360/16

(57) ABSTRACT

A head-mounted display includes a casing, a first display panel, a second display panel, a third display panel, a projection optical engine, a first thermally conductive material layer, a control module, and an imaging lens. The first display panel, the second display panel, the third display panel, and the control module are disposed in the casing. The imaging lens is disposed on the casing. The first display panel, the second display panel, and the third display panel are configured to emit image beam respectively. The control module is electrically connected to the first display panel, the second display panel, and the third display panel to adjust light intensity of the image beam respectively according to a brightness value of ambient light to adjust a surface temperature of the casing. A light intensity adjustment method of the head-mounted display is further disclosed.

### CROSS-REFERENCE TO RELATED APPLICATION

This application claims the priority benefit of China application serial no. 202410153647.1, filed on Feb. 2, 2024. The entirety of the above-mentioned patent application is hereby incorporated by reference herein and made a part of this specification.

### BACKGROUND

### Technical Field

The disclosure relates to a display and a light intensity adjustment method thereof, and more particularly, to a head-mounted display and a light intensity adjustment method thereof.

### Description of Related Art

AR glasses are products that will come into contact with skin of a user for a long time. Therefore, regulations stipulate that a surface temperature of the product must not be higher than 48 degrees, but the temperature that is more comfortable when touching the skin of the user is required to be lower than 39 degrees. Since the AR glasses are closer to ears of the user and are more sensitive to noise, the AR glasses usually use natural convection of airflow to dissipate heat. In addition, since the AR glasses are worn on the ears of the user, in order to avoid weight from placing a burden on the ears of the user, a lightweight exterior design is pursued to avoid affecting user experience.

However, under the conditions of pursuing the lightweight AR glasses, limited surface temperature, and natural convection of the airflow, power/wattage that a system of the AR glasses may handle is very limited. In the past, in a heat dissipation design of the AR glasses, light intensity and heat dissipation are usually evaluated under general usage conditions. However, under some extreme conditions, such as images with a large average picture level (APL), the temperature of the AR glasses may exceed a preset temperature, or under low workload conditions, a brightness of the AR glasses may be underestimated.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a head-mounted display and a light intensity adjustment method thereof, which has better image effects and sufficient brightness, and may provide good use experience.

Other objectives and advantages of the disclosure may be further understood from the technical features disclosed herein.

In order to achieve one, a part, or all of the above objectives or other objectives, an embodiment of the disclosure provides a head-mounted display including a casing, a first display panel, a second display panel, a third display panel, a projection optical engine, a first thermally conductive material layer, a control module, and an imaging lens. The first display panel, the second display panel, the third display panel, and the control module are disposed in the casing. The imaging lens is disposed on the casing. The first display panel, the second display panel, and the third display panel are connected to the casing through the first thermally conductive material layer, and are configured to emit a first image beam, a second image beam, and a third image beam respectively. The first image beam, the second image beam, and the third image beam are projected out of the head-mounted display through the projection optical engine and the imaging lens. The control module is electrically connected to the first display panel, the second display panel, and the third display panel to adjust light intensity of the first image beam, the second image beam, and the third image beam according to a brightness value of ambient light to adjust a surface temperature of the casing.

In order to achieve one, a part, or all of the above objectives or other objectives, an embodiment of the disclosure provides a light intensity adjustment method of a head-mounted display, which is suitable for the above head-mounted display. The light intensity adjustment method includes the following step. It is determined, through the control module, whether the brightness value of the ambient light is greater than a brightness threshold value to adjust the light intensity of the first image beam, the second image beam, and the third image beam.

Based on the above, in the head-mounted display and the light intensity adjustment method thereof according to an embodiment of the disclosure, the first display panel, the second display panel, the third display panel, and the control module are connected to the casing through the first thermally conductive material layer, so that heat generated by an operation of the head-mounted display system may be transferred to the casing through the first thermally conductive material layer. Moreover, the control module determines whether the brightness value of the ambient light is greater than the brightness threshold value to adjust the light intensity of the first image beam, the second image beam, and the third image beam emitted by the first display panel, the second display panel, and the third display panel respectively. Therefore, in the head-mounted display and the light intensity adjustment method thereof according to the embodiment of the disclosure, the image beam may maintain better image effects and have sufficient brightness when complying with regulations and maintaining wearing comfort, thereby improving the use experience.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic perspective diagram of a head-mounted display according to an embodiment of the disclosure.

FIG. 2A is a schematic cross-sectional diagram of FIG. 1.

FIG. 2B is a block diagram of FIGS. 1 and 2A.

FIG. 3 is a schematic diagram of a first display panel and multiple first light sources in a head-mounted display according to an embodiment of the disclosure.

FIG. 4 is a schematic diagram of a second display panel and multiple second light sources in a head-mounted display according to an embodiment of the disclosure.

FIG. 5 is a schematic diagram of a third display panel and multiple third light sources in a head-mounted display according to an embodiment of the disclosure.

FIG. 6 is a flow chart of a light intensity adjustment method of a head-mounted display according to an embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

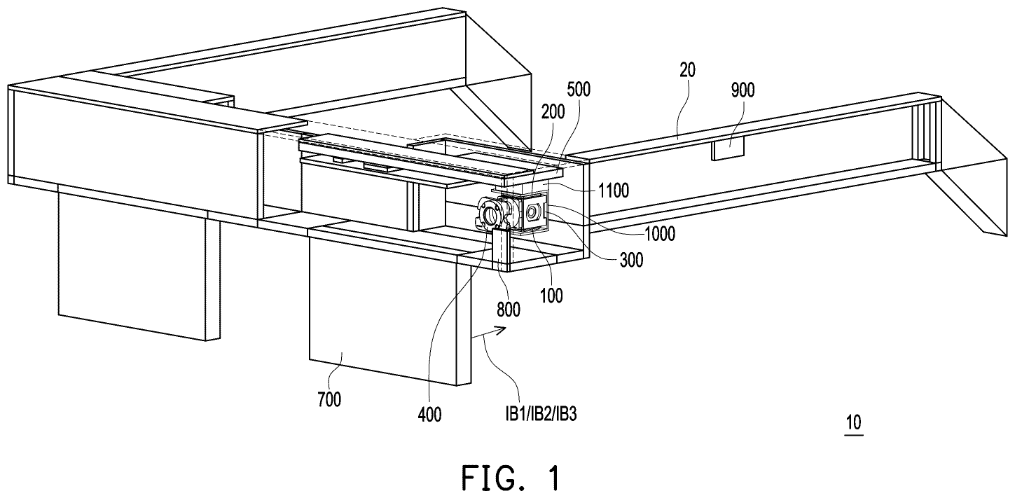

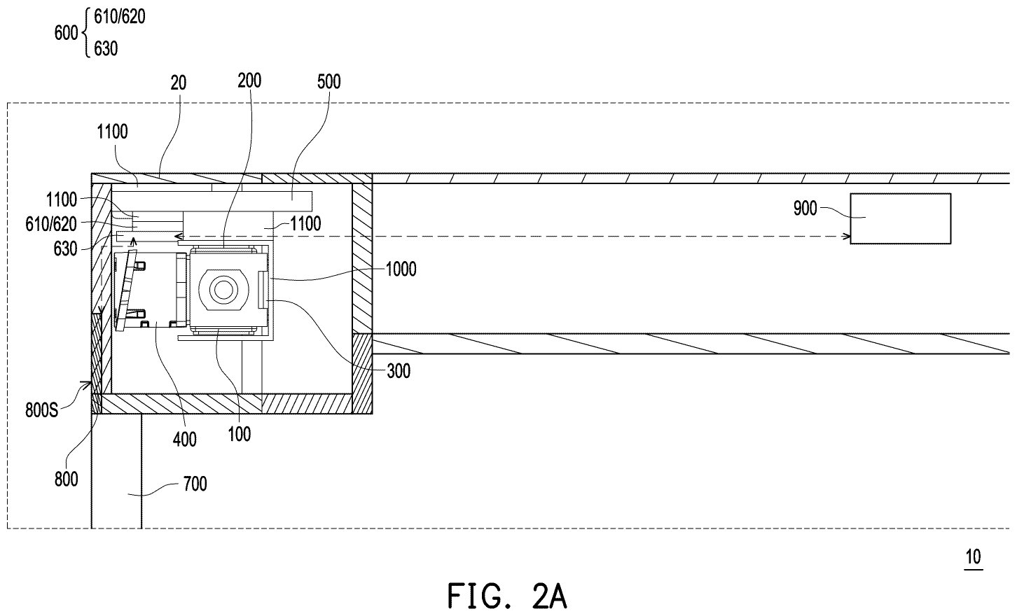

FIG. 1 is a schematic perspective diagram of a head-mounted display according to an embodiment of the disclosure. FIG. 2A is a schematic cross-sectional diagram of FIG. 1. Referring to FIGS. 1 and 2A, an embodiment of the disclosure provides a head-mounted display 10, which includes a casing 20, a first display panel 100, a second display panel 200, a third display panel 300, a projection optical engine 400, a first thermally conductive material layer 500, a control module 600, and an imaging lens 700. The first display panel 100, the second display panel 200, the third display panel 300, and the control module 600 are disposed in the casing 20. The imaging lens 700 is disposed on the casing 20. The first display panel 100, the second display panel 200, and the third display panel 300 are connected to the casing 20 through the first thermally conductive material layer 500, and are configured to emit a first image beam IB1, a second image beam IB2, and a third image beam IB3 respectively. The first image beam IB1, the second image beam IB2, and the third image beam IB3 are projected out of the head-mounted display 10 through the projection optical engine 400 and the imaging lens 700. The control module 600 is electrically connected to the first display panel 100, the second display panel 200, and the third display panel 300 to adjust light intensity of the first image beam IB1, the second image beam IB2, and the third image beam IB3 according to a brightness value of ambient light, so as to adjust a surface temperature of the casing 20.

In detail, a material of the casing 20 may be metal, plastic, etc. The casing 20 may be a spectacle frame, which may include a lens frame, a frame, and temples (not numbered). The lens frame may be provided with the imaging lens 700 to correspond to a position of eyes of a user, and the lens frame, the frame, and the temples are connected. Therefore, a portion of a surface of the casing 20 is adapted to be in contact with skin of the user, such as a head of the user. The projection optical engine 400 includes, for example, a combination of one or more optical lenses with diopter. For example, the head-mounted display 10 further includes a light waveguide (not shown) to receive the image beam from the projection optical engine 400. After the image beam is output by the projection optical engine 400, the image beam may be continuously reflected in the light waveguide and then projected to the imaging lens 700. The light waveguide is known to those skilled in the art. Therefore, the same details will not be repeated in the following. A material of the first thermally conductive material layer 500 preferably has a good thermal conductivity coefficient (>100 W/mK), such as graphene, copper foil, aluminum foil, a vapor chamber, an ultra-thin heat pipe, etc.

FIG. 2B is a block diagram of FIGS. 1 and 2A. Referring to FIG. 2B together with FIGS. 1 and 2A, the head-mounted display 10 further includes a light sensor 800 and a temperature sensor 900. The light sensor 800 and the temperature sensor 900 are respectively disposed on the casing 20, and the control module 600 is electrically connected to the light sensor 800 and the temperature sensor 900. In addition, a display panel module 11 in the head-mounted display 10 is the aforementioned first display panel 100, second display panel 200, and third display panel 300, and image beams emitted by the display panel module 11 are the first image beam IB1, the second image beam IB2, and the third image beam IB3 respectively. The first image beam IB1, the second image beam IB2, and the third image beam IB3 may be emitted by the display panel module 11 at the same time. Further, it may be clearly seen from FIG. 2B that the control module 600 is electrically connected to the display panel module 11 and the projection optical machine 400.

The head-mounted display 10 in this embodiment may be a see-through head-mounted display. The imaging lens 700 is, for example, a light-transmitting lens that is plane, curved or has diopter. When the user wears the head-mounted display 10, the ambient light may penetrate the imaging lens 700 and reach the eyes of the user. At the same time, the first image beam IB1, the second image beam IB2, and the third image beam IB3 are also projected to the eyes of the use. Therefore, the user may see a superimposed image of an environment image and the image beam. In addition, the first image beam IB1, the second image beam IB2, and the third image beam IB3 may be red, green, and blue image beams respectively, but the disclosure is not limited thereto.

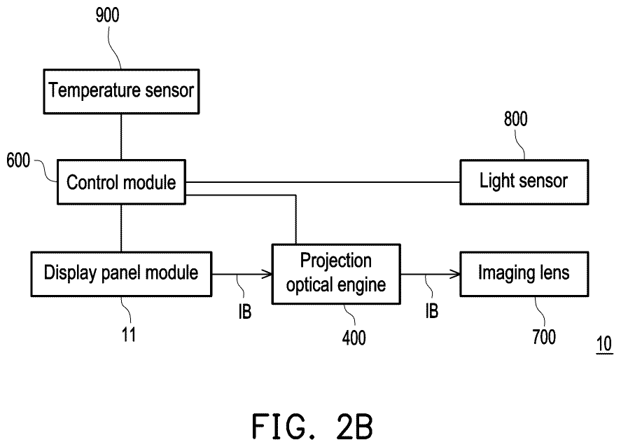

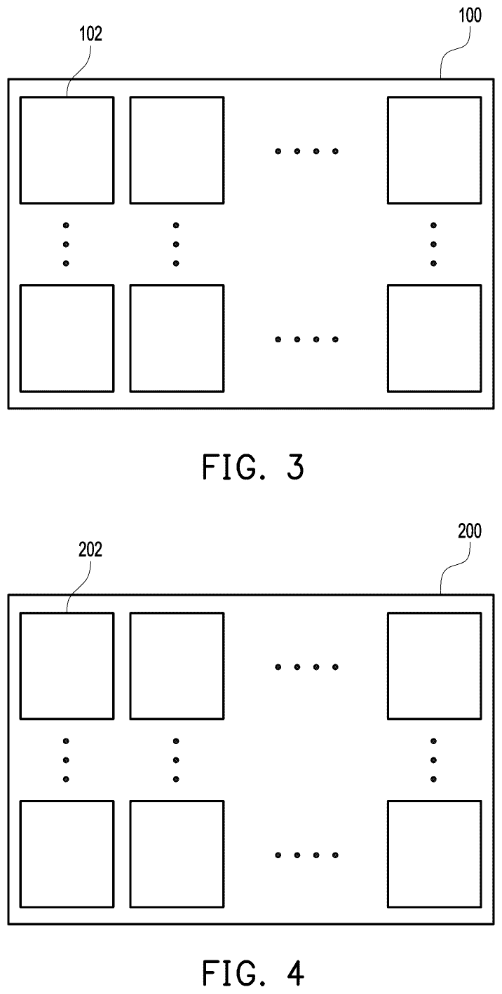

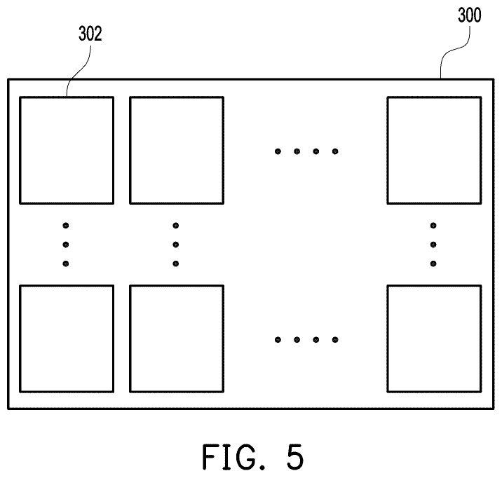

FIG. 3 is a schematic diagram of a first display panel and multiple first light sources in a head-mounted display according to an embodiment of the disclosure. FIG. 4 is a schematic diagram of a second display panel and multiple second light sources in a head-mounted display according to an embodiment of the disclosure. FIG. 5 is a schematic diagram of a third display panel and multiple third light sources in a head-mounted display according to an embodiment of the disclosure. Referring to FIGS. 3 to 5, the first display panel 100, the second display panel 200, and the third display panel 300 may be a liquid crystal display panel, an organic light emitting diode display panel, a mini LED display panel, or a micro LED display panel, but the disclosure is not limited thereto. In this embodiment, the first display panel 100 includes multiple first light sources 102 that are independently driven. The second display panel 200 includes multiple second light sources 202 that are independently driven. The third display panel 300 includes multiple third light sources 302 that are independently driven. In this embodiment, the first display panel 100 may be formed by, for example, 640*480 pixels (the resolution is 480P), 1280*720 pixels (the resolution is 720P), or 1920*1080 pixels (the resolution is 1080P). That is to say, the first display panel 100 may be a matrix light source formed by 640*480 first light sources 102, a matrix light source formed by 1280*720 first light sources 102, or a matrix light source formed by 1920*1080 first light sources. The first light source 102 is, for example, a micro LED. The second display panel 200 and the third display panel 300 may be the same as the first display panel 100. Therefore, the same details will not be repeated in the following.

Referring to FIGS. 1, 2A, and 2B again, in this embodiment, the light sensor 800 may be configured to sense the brightness value of the ambient light and transmit the brightness value of the ambient light to the control module 600. The control module 600 may adjust the light intensity of the first image beam IB1, the second image beam IB2, and the third image beam IB3 according to the brightness value of the ambient light.

In this embodiment, a sensing surface 800S of the light sensor 800 is parallel to the imaging lens 700 to accurately sense the brightness value corresponding to the ambient light felt by the eyes. In some embodiments, the sensing surface 800S of the light sensor 800 may not be completely parallel to the imaging lens 700, as long as the brightness value corresponding to the ambient light felt by the eyes may be accurately sensed.

In this embodiment, the control module 600 is configured to determine whether the surface temperature of the casing 20 is greater than a temperature threshold value Tₘax when a brightness value C_{ambient} of the ambient light is greater than a brightness threshold value Cₘₐₓ. If the surface temperature of the casing 20 is less than the temperature threshold value Tₘₐₓ, wattage requirement ratios a, b, and c of the first display panel 100, the second display panel 200, and the third display panel 300 are adjusted respectively according to the following relational expression A so as to adjust the light intensity of the first image beam IB1, the second image beam IB2, and the third image beam IB3. The relational expression A is as follows.

$${W}_{R} : {W}_{G} : {W}_{B} = A P {L}_{R} \times a : {APL}_{G} \times b : {APL}_{B} \times c$$

W_{R} is a wattage of the first display panel 100. W_{G} is a wattage of the second display panel 200. W_{B} is a wattage of the third display panel 300. APL_{R} is a light emitting ratio of the first light sources 102 of the first display panel 100. APL_{G} is a light emitting ratio of the second light sources 202 of the second display panel 200. APL_{B} is a light emitting ratio of the third light sources 302 of the third display panel 300. The wattage requirement ratios a, b, and c may determine color points, chromaticity, color temperatures, etc. of a combined image beam in a chromaticity space. That is to say, when the brightness value C_{ambient} is greater than the brightness threshold value Cₘₐₓ, it is usually necessary to deviate the image beam from the color points to present sufficient brightness. At this time, the green image beam may be chosen to increase a brightness (e.g., increasing a value of the wattage requirement ratio b), that is, increasing output of green light by reducing the color temperature, thereby increasing the brightness.

In this embodiment, if the surface temperature of the casing 20 is greater than the temperature threshold value Tₘₐₓ, the light intensity of at least one of the first image beam IB1, the second image beam IB2, and the third image beam IB3 is adjusted. For example, the brightness is maintained without reducing light intensity of the green image beam, and it is chosen to reduce light intensity of red or blue image beam, thereby maintaining the brightness while avoiding a temperature of the head-mounted display from being too high and affecting user experience.

In this embodiment, the control module 600 includes a computation element 610, an electric sensing element 620, and a circuit substrate 630. The computation element 610 and the electric sensing element 620 are disposed on the circuit substrate 630. The electric sensing element 620 is configured to sense a voltage or a current passing through the circuit substrate 630 to obtain a voltage value or a current value. The computation element 610 is configured to receive the voltage value or the current value and calculate a wattage of the control module 600 according to the voltage value and/or the current value, and the computation element 610 adjusts the light intensity of the first image beam IB1, the second image beam IB2, and the third image beam IB3 according to the brightness value of the ambient light. In other embodiments, the control module 600 may be further provided with other electronic elements for computation, such as electronic elements for processing image signals and electronic elements for processing operating systems, but the disclosure is not limited thereto.

In this embodiment, the computation element 610 includes, for example, a central processing unit (CPU), a microprocessor, a digital signal processor (DSP), a programmable controller, a programmable logic device (PLD), or other similar devices or a combination of the devices. The disclosure is not limited thereto. In addition, in an embodiment, each of functions of the computation element 610 may be implemented as multiple program codes. The program codes will be stored in a memory unit, and the computation element 610 will execute the program codes. In addition, in an embodiment, each of the functions of the computation element 610 may be implemented as one or more circuits. The disclosure is not limited to using software or hardware to implement each of the functions of the computation element 610.

In this embodiment, the control module 600 is further configured to calculate the light emitting ratio of the first light sources 102, the light emitting ratio of the second light sources 202, and the light emitting ratio of the third light sources 302 according to the image signal, and when it is determined that the brightness value C_{ambient} of the ambient light is less than or equal to the brightness threshold value Cₘₐₓ, adjust the light intensity of the first image beam IB1, the second image beam IB2, and the third image beam IB3 according to a first relational expression, a second relational expression, and a third relational expression respectively. The first relational expression, the second relational expression, and the third relational expression are as follows respectively.

$${W}_{R} = ( {Power}_{max} - {Power}_{IC} ) \times \frac{A P {L}_{R} \times a}{( A P {L}_{R} \times a + A P {L}_{G} \times b + A P {L}_{B} \times c )}$$

$${W}_{G} = ( {Power}_{max} - {Power}_{IC} ) \times \frac{A P {L}_{G} \times b}{( A P {L}_{R} \times a + A P {L}_{G} \times b + A P {L}_{B} \times c )}$$

$${W}_{B} = ( {Power}_{max} - {Power}_{IC} ) \times \frac{A P {L}_{B} \times c}{( A P {L}_{R} \times a + A P {L}_{G} \times b + A P {L}_{B} \times c )}$$

W_{R} is the wattage of the first display panel 100. W_{G} is the wattage of the second display panel 200. W_{B} is the wattage of the third display panel 300. Powerₘₐₓ is a preset maximum wattage of the head-mounted display 10. Power_{IC} is the wattage of the control module 600 calculated according to the voltage value or the current value. APL_{R} is the light emitting ratio of the first light sources 102 of the first display panel 100. APL_{G} is the light emitting ratio of the second light sources 202 of the second display panel 200. APL_{B} is the light emitting ratio of the third light sources 302 of the third display panel 300. In addition, a is the wattage requirement ratio of the first display panel 100, b is the wattage requirement ratio of the second display panel 200, and c is the wattage requirement ratio of the third display panel 300.

For example, the resolution of each of the display panels is 1920*1080. If the image signal is to control 960*540 pixels in each of the display panels to emit the light of 100%, then APL_{R}, APL_{G}, and APL_{B} are all 25%, and APL is 25%. That is to say, APL is determined by the combined first image beam IB1, second image beam IB2, and third image beam IB3, that is, by APL_{R}, APL_{G}, and APL_{B}.

That is to say, when the brightness value C_{ambient} is greater than the brightness threshold value Cₘax, the control module 600 determines whether the surface temperature of the casing 20 is greater than the temperature threshold value Tₘₐₓ. If the surface temperature of the casing 20 is less than the temperature threshold value Tₘₐₓ, the wattage requirement ratios a, b, and c are adjusted according to the relational expression A so as to adjust the light intensity of the first image beam IB1, the second image beam IB2, and the third image beam IB3. In addition, if the surface temperature of the casing 20 is greater than the temperature threshold value Tₘₐₓ, the light intensity of at least one of the first image beam IB1, the second image beam IB2, and the third image beam IB3 is adjusted, for example, to maintain the brightness without reducing the light intensity of the green image beam and choose to reduce the light intensity of the red or blue image beam. In addition, when the brightness value C_{ambient} is less than or equal to the brightness threshold value Cₘₐₓ, the light intensity of the first image beam IB1, the second image beam IB2, and the third image beam IB3 are adjusted according to the first relational expression, the second relational expression, and the third relational expression respectively. Therefore, the head-mounted display 10 determines the wattage W_{R}, W_{G}, and W_{B} of the first display panel 100, the second display panel 200, and the third display panel 300 according to the image signals (including the light emitting ratios APL_{R}, APL_{G}, and APL_{B}) and in use environments.

Continuing to refer to FIGS. 1, 2A, and 2B, in this embodiment, the temperature sensor 900 may be configured to sense the surface temperature of the casing 20. In some embodiments, the temperature sensor 900 may be disposed in the casing 20 to sense the surface temperature of the casing 20. In detail, the temperature sensor 900 may be disposed on the temples of the casing 20, but the disclosure is not limited thereto. Based on the aforementioned implementation of determining whether the surface temperature of the casing 20 is greater than the temperature threshold value Tₘₐₓ by the control module 600, the temperature threshold value Tₘₐₓ may be set according to requirements, such as setting a temperature regulated by regulations or a temperature suitable for skin contact with the user, but the disclosure is not limited thereto.

Continuing to refer to FIGS. 1 and 2A, in this embodiment, the head-mounted display 10 further includes a second thermally conductive material layer 1000. The second thermally conductive material layer 1000 is, for example, graphene, copper foil, aluminum foil, a vapor chamber, an ultra-thin heat pipe, etc. The second thermally conductive material layer 1000 is disposed in the casing 20. The second thermally conductive material layer 1000 is in thermal contact with the first display panel 100, the second display panel 200, and the third display panel 300 at the same time, and heat generated by the first display panel 100, the second display panel 200, and the third display panel 300 is transferred to the casing 20 through the second thermally conductive material layer 1000 and the first thermally conductive material layer 500.

Continuing to refer to FIGS. 1 and 2A, in this embodiment, the head-mounted display 10 further includes multiple thermal interface material (TIM) layers 1100. The thermal interface material layer 1100 is disposed in the casing 20 and is connected between the second thermally conductive material layer 1000 and the first thermally conductive material layer 500, between the control module 600 and the first thermally conductive material layer 500, and/or between the casing 20 and the first thermally conductive material layer 500. Main components of the thermal interface material layer 1100 are basic materials and filling materials. The basic materials provide an ability to fill gaps, and are mostly soft and deformable materials, such as a silicone resin (polysiloxane or polymerized siloxane)/silicon. A purpose of the filling materials is to increase thermal conductivity of the basic material, and commonly used materials are metal or ceramic powder. That is to say, one side of the thermally conductive material layer is connected to the control module 600 and the display panel through the thermal interface material layer 1100, and another side is connected to the casing 20 through the thermal interface material layer 1100, so that the thermally conductive material layer may absorb the heat generated by the operation of the system to be evenly transferred to the casing 20, and the casing 20 then dissipates the heat out of the head-mounted display 10.

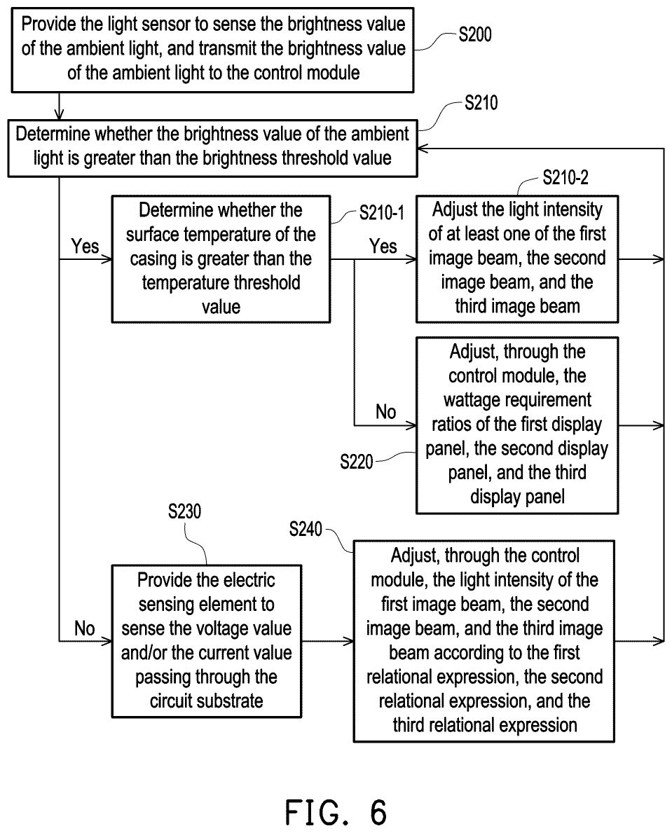

FIG. 6 is a flow chart of a light intensity adjustment method of a head-mounted display according to an embodiment of the disclosure. Referring to FIG. 6, in this embodiment, the light intensity adjustment method includes the following steps. In step S200, the light sensor 800 is provided to sense the brightness value C_{ambient} of the ambient light, and transmit the brightness value C_{ambient} of the ambient light to the control module 600. In step S210, the control module 600 determines whether the brightness value C_{ambient} of the ambient light is greater than the brightness threshold value Cₘax to adjust the light intensity of the first image beam IB1, the second image beam IB2, and the third image beam IB3. When the control module 600 determines that the brightness value C_{ambient} of the ambient light is greater than the brightness threshold value Cₘax, in step S210-1, the control module 600 further determines whether the surface temperature of the casing 20 is greater than the temperature threshold value Tₘₐₓ. If the surface temperature of the casing 20 is less than the temperature threshold value Tₘₐₓ, in step S220, the wattage requirement ratios a, b, and c of the first display panel 100, the second display panel 200, and the third display panel 300 are adjusted respectively through the control module 600. If the surface temperature of the casing 20 is greater than the temperature threshold value Tₘax, in step S210-2, the light intensity of at least one of the first image beam IB1, the second image beam IB2, and the third image beam IB3 is adjusted through the control module 600.

In this embodiment, the light intensity adjustment method of the head-mounted display 10 further includes the following steps. In step S230, the electric sensing element 620 is provided to sense the voltage or the current passing through the circuit substrate 630 to obtain the voltage value or the current value. The voltage value or the current value is received through the computation element 610, and the wattage of the control module 600 is calculated according to the voltage value and/or the current value. In addition, the computation element 610 adjusts the light intensity of the first image beam IB1, the second image beam IB2, and the third image beam IB3 according to the brightness value of the ambient light.

In this embodiment, the light intensity adjustment method of the head-mounted display 10 further includes the following steps. The control module 600 calculates the light emitting ratio APL_{R} of the first light sources 102, the light emitting ratio APL_{G} of the second light sources 202, and the light emitting ratio APL_{B} of the third light sources 302 according to the image signal. In step S240, if the control module 600 determines that the brightness value C_{ambient} of the ambient light is less than or equal to the brightness threshold value Cₘₐₓ, the light intensity of the first image beam IB1, the second image beam IB2, and the third image beam IB3 are adjusted according to the first relational expression, the second relational expression, and the third relational expression respectively.

Based on the above, in the head-mounted display and the light intensity adjustment method thereof according to an embodiment of the disclosure, the head-mounted display includes the casing, the first display panel, the second display panel, the third display panel, the projection optical machine, the first thermally conductive material layer, the control module, and the imaging lens. The first display panel, the second display panel, the third display panel, and the control module are connected to the casing through the first thermally conductive material layer, so that the heat generated by the operation of the system may be transferred to the casing through the first thermally conductive material layer. Moreover, the control module determines whether the brightness value of the ambient light is greater than the brightness threshold value to adjust the light intensity of the first image beam, the second image beam, and the third image beam emitted by the first display panel, the second display panel, and the third display panel. Therefore, in the head-mounted display and the light intensity adjustment method thereof according to the embodiment of the disclosure, the image beam may maintain better image effects and have sufficient brightness when complying with regulations and maintaining wearing comfort, thereby improving the use experience.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A head-mounted display, comprising a casing, a first display panel, a second display panel, a third display panel, a projection optical engine, a first thermally conductive material layer, a control module, and an imaging lens, wherein the first display panel, the second display panel, the third display panel, and the control module are disposed in the casing, and the imaging lens is disposed on the casing, wherein
the first display panel, the second display panel, and the third display panel are connected to the casing through the first thermally conductive material layer, and are configured to emit a first image beam, a second image beam, and a third image beam respectively, and the first image beam, the second image beam, and the third image beam are projected out of the head-mounted display through the projection optical engine and the imaging lens; and
the control module is electrically connected to the first display panel, the second display panel, and the third display panel, the control module is configured to adjust light intensity of the first image beam, the second image beam, and the third image beam according to a brightness value of ambient light to adjust a surface temperature of the casing.

2. The head-mounted display according to claim 1, wherein the first display panel comprises a plurality of first light sources that are independently driven, the second display panel comprises a plurality of second light sources that are independently driven, and the third display panel comprises a plurality of third light sources that are independently driven.

3. The head-mounted display according to claim 1, further comprising:
a light sensor disposed on the casing and electrically connected to the control module, wherein the light sensor is configured to sense the brightness value of the ambient light and transmit the brightness value of the ambient light to the control module.

4. The head-mounted display according to claim 3, wherein a sensing surface of the light sensor is parallel to the imaging lens.

5. The head-mounted display according to claim 3, wherein the control module is configured to:
determine whether the surface temperature of the casing is greater than a temperature threshold value when it is determined that the brightness value of the ambient light is greater than a brightness threshold value, and if the surface temperature of the casing is less than the temperature threshold value, adjust wattage requirement ratios of the first display panel, the second display panel, and the third display panel.

6. The head-mounted display according to claim 3, wherein the control module is configured to:
determine whether the surface temperature of the casing is greater than a temperature threshold value when it is determined that the brightness value of the ambient light is greater than a brightness threshold value, and if the surface temperature of the casing is greater than the temperature threshold value, adjust the light intensity of at least one of the first image beam, the second image beam, and the third image beam.

7. The head-mounted display according to claim 3, wherein the control module comprises a computation element, an electric sensing element, and a circuit substrate, and the computation element and the electric sensing element are disposed on the circuit substrate, wherein
the electric sensing element is configured to sense a voltage or a current passing through the circuit substrate to obtain a voltage value or a current value;
the computation element is configured to receive the voltage value or the current value and calculate a wattage of the control module according to the voltage value and/or the current value, and the computation element adjusts the light intensity of the first image beam, the second image beam, and the third image beam according to the brightness value of the ambient light.

8. The head-mounted display according to claim 7, wherein the first display panel comprises a plurality of first light sources that are independently driven, the second display panel comprises a plurality of second light sources that are independently driven, the third display panel comprises a plurality of third light sources that are independently driven, and the control module is configured to:
calculate a light emitting ratio of the first light sources, a light emitting ratio of the second light sources, and a light emitting ratio of the third light sources according to an image signal; and
when it is determined that the brightness value of the ambient light is less than or equal to a brightness threshold value, adjust the light intensity of the first image beam, the second image beam, and the third image beam according to a first relational expression, a second relational expression, and a third relational expression respectively, wherein
the first relational expression, the second relational expression, and the third relational expression are respectively:
$${W}_{R} = ( {Power}_{max} - {Power}_{IC} ) \times \frac{A P {L}_{R} \times a}{( A P {L}_{R} \times a + A P {L}_{G} \times b + A P {L}_{B} \times c )}$$
$${W}_{G} = ( {Power}_{max} - {Power}_{IC} ) \times \frac{A P {L}_{G} \times b}{( A P {L}_{R} \times a + A P {L}_{G} \times b + A P {L}_{B} \times c )}$$
$${W}_{B} = ( {Power}_{max} - {Power}_{IC} ) \times \frac{A P {L}_{B} \times c}{( A P {L}_{R} \times a + A P {L}_{G} \times b + A P {L}_{B} \times c )}$$
wherein W_{R} is a wattage of the first display panel, W_{G} is a wattage of the second display panel, W_{B} is a wattage of the third display panel, Powerₘₐₓ is a preset maximum wattage of the head-mounted display, Power_{IC} is the wattage of the control module calculated according to the voltage value or the current value, APL_{R} is the light emitting ratio of the first light sources of the first display panel, APL_{G} is the light emitting ratio of the second light sources of the second display panel, APL_{B} is the light emitting ratio of the third light sources of the third display panel, a is a wattage requirement ratio of the first display panel, b is a wattage requirement ratio of the second display panel, and c is a wattage requirement ratio of the third display panel.

9. The head-mounted display according to claim 1, further comprising:
a temperature sensor disposed on the casing and electrically connected to the control module, wherein the temperature sensor is configured to sense the surface temperature of the casing.

10. The head-mounted display according to claim 1, further comprising:
a second thermally conductive material layer disposed in the casing, wherein the second thermally conductive material layer is in thermal contact with the first display panel, the second display panel, and the third display panel at the same time, and heat generated by the first display panel, the second display panel, and the third display panel is transferred to the casing through the second thermally conductive material layer and the first thermally conductive material layer.

11. The head-mounted display according to claim 10, further comprising:
a plurality of thermal interface material layers disposed in the casing and connected between the second thermally conductive material layer and the first thermally conductive material layer, between the control module and the first thermally conductive material layer, and/or between the casing and the first thermally conductive material.

12. A light intensity adjustment method of a head-mounted display, suitable for the head-mounted display according to claim 1, wherein the light intensity adjustment method comprises:
determining whether the brightness value of the ambient light is greater than a brightness threshold value and adjusting the light intensity of the first image beam, the second image beam, and the third image beam through the control module.

13. The light intensity adjustment method of the head-mounted display according to claim 12, further comprising:
providing a light sensor to sense the brightness value of the ambient light and transmit the brightness value of the ambient light to the control module.

14. The light intensity adjustment method of the head-mounted display according to claim 13, further comprising:
determining whether the brightness value of the ambient light is greater than the brightness threshold value and whether the surface temperature of the casing is greater than a temperature threshold value through the control module, and if the surface temperature of the casing is less than the temperature threshold value, adjusting a wattage requirement ratio of the first display panel, a wattage requirement ratio of the second display panel, and a wattage requirement ratio of the third display panel through the control module.

15. The light intensity adjustment method of the head-mounted display according to claim 13, further comprising:
determining whether the brightness value of the ambient light is greater than the brightness threshold value and whether the surface temperature of the casing is greater than a temperature threshold value through the control module, and if the surface temperature of the casing is greater than the temperature threshold value, adjusting the light intensity of at least one of the first image beam, the second image beam, and the third image beam through the control module.

16. The light intensity adjustment method of the head-mounted display according to claim 13, wherein the control module comprises a computation element, an electric sensing element, and a circuit substrate, and the light intensity adjustment method of the head-mounted display further comprises:
providing the electric sensing element to sense a voltage or a current passing through the circuit substrate to obtain a voltage value or a current value; and
receiving, the voltage value or the current value and calculating a wattage of the control module according to the voltage value and/or the current value through the computation element, and adjusting the light intensity of the first image beam, the second image beam, and the third image beam according to the brightness value of the ambient light through the computation element.

17. The light intensity adjustment method of the head-mounted display according to claim 16, wherein the first display panel comprises a plurality of first light sources that are independently driven, the second display panel comprises a plurality of second light sources that are independently driven, the third display panel comprises a plurality of third light sources that are independently driven, and the light intensity adjustment method further comprises:
calculating a light emitting ratio of the first light sources, a light emitting ratio of the second light sources, and a light emitting ratio of the third light sources through the control module according to an image signal;
if the control module determines that the brightness value of the ambient light is less than or equal to the brightness threshold value, adjusting the light intensity of the first image beam, the second image beam, and the third image beam according to a first relational expression, a second relational expression, and a third relational expression respectively, wherein
the first relational expression, the second relational expression, and the third relational expression are respectively:
$${W}_{R} = ( {Power}_{max} - {Power}_{IC} ) \times \frac{A P {L}_{R} \times a}{( A P {L}_{R} \times a + A P {L}_{G} \times b + A P {L}_{B} \times c )}$$
$${W}_{G} = ( {Power}_{max} - {Power}_{IC} ) \times \frac{A P {L}_{G} \times b}{( A P {L}_{R} \times a + A P {L}_{G} \times b + A P {L}_{B} \times c )}$$
$${W}_{B} = ( {Power}_{max} - {Power}_{IC} ) \times \frac{A P {L}_{B} \times c}{( A P {L}_{R} \times a + A P {L}_{G} \times b + A P {L}_{B} \times c )}$$
wherein W_{R} is a wattage of the first display panel, W_{G} is a wattage of the second display panel, W_{B} is a wattage of the third display panel, Powerₘₐₓ is a preset maximum wattage of the head-mounted display, Power_{IC} is the wattage of the control module calculated according to the voltage value or the current value, APL_{R} is the light emitting ratio of the first light sources of the first display panel, APL_{G} is the light emitting ratio of the second light sources of the second display panel, APL_{B} is the light emitting ratio of the third light sources of the third display panel, a is a wattage requirement ratio of the first display panel, b is a wattage requirement ratio of the second display panel, and c is a wattage requirement ratio of the third display panel.
